(19) United States
(12) Patent Application Publication
(10) Pub. No.: US 2006/0261754 A1
(43) Pub. Date: Nov. 23, 2006

(54) LED driving circuit having dimming circuit

(75) Inventor: Sang Yun Lee, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/435,890

(22) Filed: May 18, 2006

(30) Foreign Application Priority Data
May 18, 2005 (KR) 10-2005-41526

(51) Int. Cl. H05B 37/02

(52) U.S. Cl. 315/291

(57) ABSTRACT

The invention relates to an LED driving circuit having a dimming circuit, which includes a PWM driver for providing a switching pulse having a width adjustable according to a voltage value detected by a voltage detecting resistor to control on/off durations of a switch. The circuit also includes a comparator for comparing the voltage value detected from the voltage detection resistor with a predetermined dimming voltage value, and a PWM controller for generating a control signal to increase the ‘on’ duration of the switching pulse outputted from the PWM driver if a comparison value from the comparator is increased, and to decrease the ‘on’ duration of the switching pulse outputted from the PWM driver if the comparison value from the comparator is decreased. The width of the switching pulse outputted from the PWM driver is controlled according to the predetermined dimming voltage value to adjust luminance of an LED.

### CLAIM OF PRIORITY

This application claims the benefit of Korean Patent Application No. 2005-41526 filed on May 18, 2005, in the Korean Intellectual Property Office, the disclosure of which is incorporated herein by reference.

### BACKGROUND OF THE INVENTION

1. Field of the Invention

The present invention relates to a light emitting diode (LED) driving circuit having a dimming circuit, and more particularly, which compares a detected voltage value provided to a PWM driver with a predetermined dimming voltage, and according to a difference between these two values, controls an ‘on’ duration of a switching pulse outputted from the PWM driver, thereby simply adjusting luminance of an LED without using a variable resistor.

2. Description of the Related Art

A general Cold Cathode Fluorescent Lamp (hereinafter referred to as CCFL) for a backlight of a Liquid Crystal Display (hereinafter referred to as LCD) uses mercury gas. Thus, it has drawbacks in that it is prone to environmental pollution, has a slow response rate and low color reproducibility, and is inappropriate for miniaturization of an LCD panel.

On the other hand, a Light Emitting Diode (hereinafter referred to as LED) has merits in that it is environmentally friendly, has a prompt response rate in nanoseconds, which is effective for a video signal stream, is possible for impulsive driving, and has more than 100% of color reproducibility. Further, the light amounts of red, green and blue LEDs can be adjusted to manipulate luminance and color temperature, and also the LED is appropriate for miniaturization of an LCD panel. Due to these merits, the LED is actively adopted as a light source for a backlight for an LCD panel, etc.

As described above, in case of using a plurality of LEDs connected in series in an LCD backlight, a driving circuit is required to provide constant current to the LEDs. Particularly, a dimming circuit for adjusting luminance is required when the user adjusts luminance and color temperature or compensates temperature. FIGS. 1(a) and (b) show a conventional LED driving circuit.

First, FIG. 1(a) is a circuit diagram illustrating an example of an LED driving circuit using a conventional buck DC-DC converter. As shown in FIG. 1 (a), in the LED driving circuit using the conventional buck DC-DC converter, an inductor L and LED array are connected in series at a positive end of a direct current source Vin, and a diode D is connected in parallel with the inductor L and the LED array 11. In addition, a switch 13 and a voltage detection resistor Rs are connected in series to a connection node of the LED array 11 and the diode D, and a negative end of the direct current source Vin. A voltage value detected at the voltage detection resistor Rs is inputted to a PWM driver 12, which adjusts an on/off duty ratio of the switch 13 according to the detected voltage value. As shown in FIG. 1(a), the switch 13 can adopt a Metal Oxide Semiconductor Field-Effect Transistor (MOSFET), which can be used as a switch when a switching pulse is applied to a gate voltage of the MOSFET.

When the switch 13 is ‘on’, the current supplied from the direct current source Vin is transmitted to the LED array via the inductor L. At this point, energy is accumulated in the inductor L. When the switch 13 is ‘off’, power is supplied to the LED array 11 by the energy accumulated in the inductor L. The PWM controller 12 adjusts the on/off duty ratio of the switch 13 in accordance with the resistance value of the voltage detection resistor Rs to regulate power supplied to the LED array 11.

FIG. 1(b) is a circuit diagram illustrating an example of an LED driving circuit using a conventional boost DC-DC converter. As shown in FIG. 1(b), in the LED driving circuit adopting the conventional boost DC-DC converter, an inductor L and a diode D are connected in series to a positive end of a direct current source Vin, and a capacitor C and an LED array 11 are connected in parallel with each other between the diode and a negative end of direct current source Vin. A switch 13 and a voltage detection resistor Rs are connected in series between a connection node of the inductor L and the diode D and the negative end of direct current Vin. A voltage value detected at the voltage detection resistor Rs is inputted to a PWM driver 12, which adjusts an on/off duty ratio of the switch 13 according to the detected voltage value. As shown in FIG. 1(b), the switch 13 can adopt a MOSFET, which can be used as a switch by adjusting the gate voltage thereof.

When the switch 13 is ‘on’, the current supplied to the direct current source Vin flows through the inductor L and the switch S, and energy is stored in the inductor L. When the switch 13 is ‘off’, the sum of the energy accumulated in the direct current source Vin and that of the inductor L pass through the diode D and transmitted to the LED array 11. Here, the voltage is smoothed by a smoothing capacitor C and transmitted to the LED array 11, and its value is greater than or equal to an input voltage Vin.

In such a conventional LED driving circuit, a resistance value of a voltage detection resistor Rs is adjusted to modify a voltage value detected from the voltage detection resistor Rs, thereby manipulating the luminance of an LED. In this conventional method, a variable resistor is used for the voltage detection resistor Rs to manipulate luminance. However, this method also bears a problem in which the voltage detection resistor Rs has to use a wattage resistor, which complicates variation. Further, in case of using a plurality of LEDs emitting plural colors, a driving circuit is needed for each of the different colors. However, the voltage detection resistors Rs of the driving circuits have different resistance values in practice, adversely affecting the adjustment of luminance, regulation of color coordinates and resultant color uniformity.

### SUMMARY OF THE INVENTION

The present invention has been made to solve the foregoing problems of the prior art and it is therefore an object of the present invention to provide an LED driving circuit having a dimming circuit capable of adjusting the luminance of an LED without using a variable resistor.

According to an aspect of the invention for realizing the object, there is provided a light emitting diode (LED)driving circuit having a dimming circuit including: a Pulse Width Modulation (PWM) driver for providing a switching pulse having a width adjustable according to a voltage value detected by a voltage detecting resistor to control on/off durations of a switch; a comparator for comparing the voltage value detected from the voltage detection resistor with a predetermined dimming voltage value; and a PWM controller for generating a control signal to increase the ‘on’ duration of the switching pulse outputted from the PWM driver if a comparison value from the comparator is increased, and to decrease the ‘on’ duration of the switching pulse outputted from the PWM driver if the comparison value from the comparator is decreased. Thereby, the width of the switching pulse outputted from the PWM driver is controlled according to the predetermined dimming voltage value to adjust luminance of an LED.

According to an embodiment of the invention, the LED driving circuit having a dimming circuit may further include an amplifier for amplifying the voltage value detected from the voltage detecting resistor to provide to the comparator.

Preferably, the PWM driver is a PWM IC having a comp terminal which increases the ‘on’ duration of the switching pulse when an applied voltage is increased and which decreases the ‘on’ duration of the switching pulse when the applied voltage is decreased, and the control signal from the PWM controller is applied to the comp terminal.

Preferably, the PWM controller includes a base for receiving the comparison value applied from the comparator, an emitter connected to a comp terminal, and an npn transistor having a grounded collector.

In a preferred embodiment of the invention, the LED driving circuit having a dimming circuit may further include: an operator for operating to adjust luminance of the LED; a microcontroller for generating a luminance adjusting signal in accordance with the operation by the operator; and a digital-analogue converter for outputting the luminance adjusting signal generated from the microcontroller as the predetermined dimming voltage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 (a) is a circuit diagram illustrating an LED driving circuit using a conventional buck DC-DC converter;

FIG. 1 (b) is a circuit diagram illustrating an LED driving circuit using a conventional boost DC-DC converter;

FIG. 2 is a block diagram illustrating an LED driving circuit according to an embodiment of the present invention;

FIG. 3 is a detailed circuit diagram illustrating the LED driving circuit shown in FIG. 2; and

FIG. 4 is a block diagram illustrating an LED driving circuit according to another embodiment of the present invention.

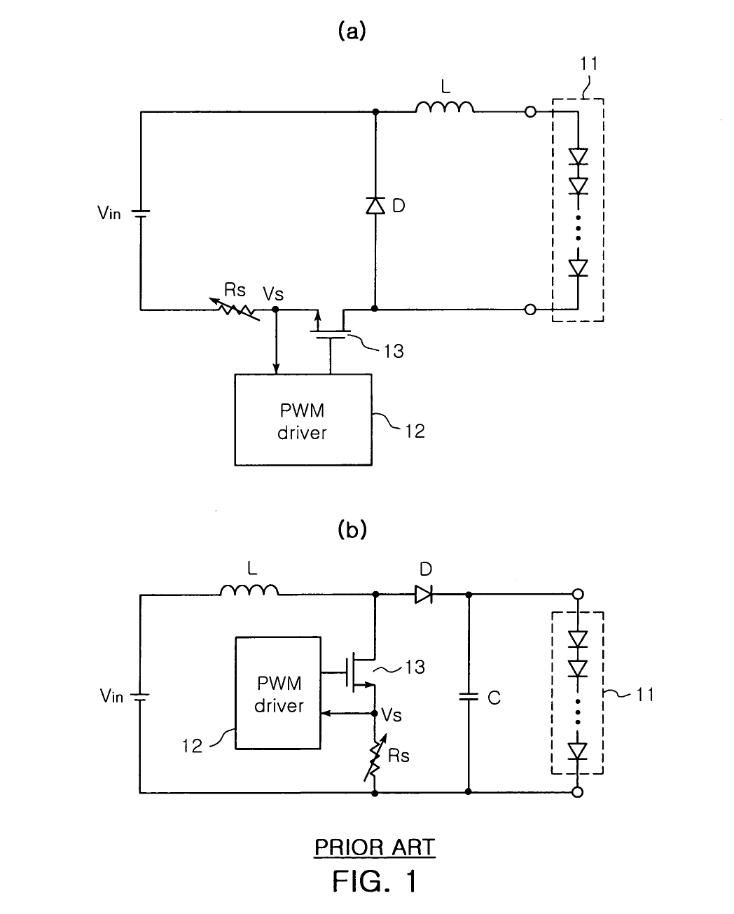

### DETAILED DESCRIPTION OF THE PREFERRED EMBODIMENT

Preferred embodiments of the present invention will now be described in detail with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions are exaggerated for clarity and the same reference numerals are used throughout to designate the same or similar components.

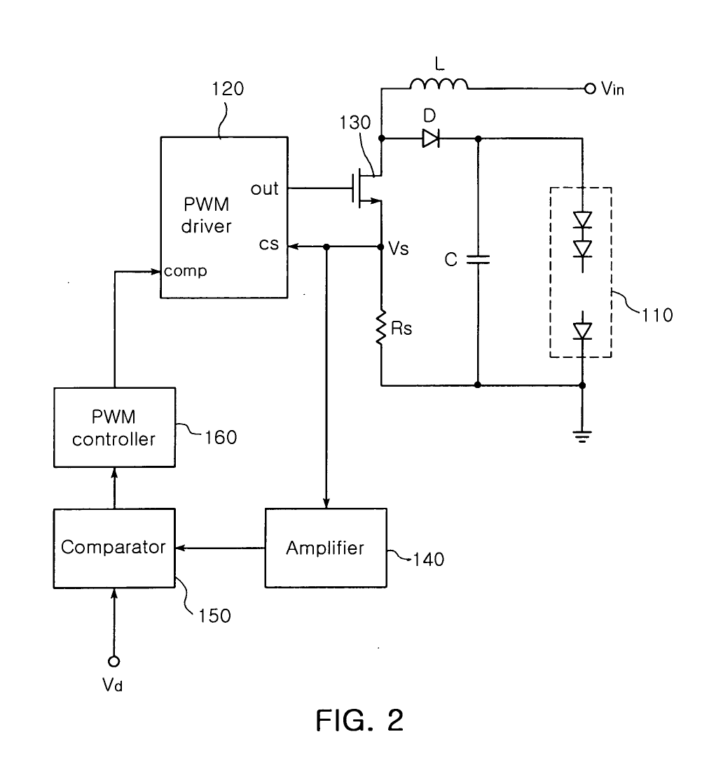

FIG. 2 is a block diagram illustrating an LED driving circuit having a dimming circuit according to an embodiment of the present invention. FIG. 2 illustrates an LED driving circuit having a boost DC-DC converter but the present invention is not limited thereto, and is applicable to LED driving circuits having any kind of DC-DC converters adopting the PWM method. With reference to FIG. 2, the LED driving circuit according to an embodiment of the present invention is provided with a boost DC-DC converter having a PWM driver 120 which provides a switching pulse having a width adjustable according to a detected voltage by a voltage detection resistor Rs to a switch to control on/off durations of the switch 130. The output end of the DC-DC converter is connected to an LED array 110.

In addition, the LED driving circuit according to a preferred embodiment of the present invention includes a comparator 150 for comparing the voltage value Vs detected by the voltage detection resistor Rs and a predetermined dimming voltage value Vd; and a PWM controller 160 for generating a control signal to increase the ‘on’ duration of the switching pulse outputted from the comparator 150 when a comparison value from the comparator 150 is increased, and to decrease the ‘on’ duration of the switching pulse outputted from the PWM driver 120 when the comparison value from the comparator 150 is decreased. These are the main components that constitute the dimming circuit which controls the width of the switching pulse outputted from the PWM driver 120 according to the dimming voltage value Vd to adjust the luminance of the LED. In addition, the LED driving circuit may further include an amplifier 140 which amplifies the detected voltage value Vs detected by the voltage detection resistor Rs and provides the amplified voltage value to the comparator 150.

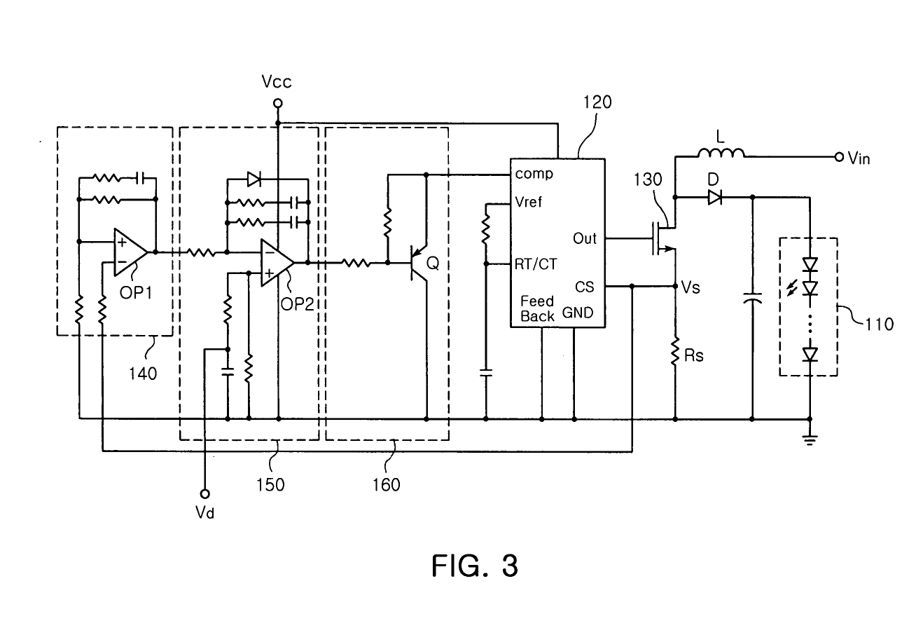

FIG. 3 is a more detailed circuit diagram illustrating the LED driving circuit shown in FIG. 2. With reference to FIG. 3, the PWM driver 120 is a PWM IC having a comp terminal which increases the ‘on’ duration of the outputted switching pulse when the applied voltage is increased, and decreases the ‘on’ duration of the outputted switching pulse when the applied voltage is decreased. In this case, the control signal of the PWM controller 160 is applied to the comp terminal.

The amplifier 140 amplifies the voltage Vs detected by the voltage detection resistor Rs to a predetermined level using a first operation amplifier OP1.

The comparator 150 includes a second amplifier OP2 which receives the detected voltage Vs, amplified by the amplifier 140, through an inversion terminal and receives the predetermined dimming voltage Vd from the outside through a non-inversion end so as to compare the two values.

The PWM controller 160 includes a base which receives the comparison value from the comparator 150, an emitter connected to the comp terminal, and an npn transistor Q having a grounded collector.

Now, the operation of the LED driving circuit according to an embodiment of the present invention will be described with reference to FIG. 3. If desired to decrease the current supplied to the LED array to lower the luminance, the user decreases the dimming voltage Vd first.

Next, the comparator 150 compares the voltage Vs detected by the voltage detection resistor Rs and amplified by the amplifier 140 with the dimming voltage Vd. Since the dimming voltage Vd is received through a non-inversion terminal and the detected voltage Vs is received through an inversion terminal, if the dimming voltage Vd is decreased, the value outputted from the comparator 150 is also decreased.

When the decreased comparison voltage value is applied to the base of the npn transistor Q in the PWM controller 160, since the collector of the npn transistor Q is grounded, the current running on the emitter of the npn transistor Q is decreased. Thereby, the voltage of the comp terminal of the PWM IC 120 is decreased and accordingly the ‘on’ duration of the switching pulse outputted to the switch 130 is decreased, and in turn, the current supplied to the LED array 110 is decreased, thus lowering the luminance. The same operational steps are taken to increase the luminance.

The LED driving circuit according to the present invention not only can adjust the luminance of the LED array according to the dimming voltage received from the outside but also can regulate the constant current that maintains the current supplied to the LED at a constant level given that the dimming voltage is kept at a constant level. The regulation of the constant current will be described with reference to FIG. 3. For example, if the dimming voltage is maintained at a constant level but the driving voltage is increased by external disturbance, the voltage detected by the voltage detection resistor Rs is increased. Since the detected voltage Vs is received through the inversion terminal of the operation amplifier 2 in the comparator 150, and the dimming voltage is received through the non-inversion terminal, the output from the comparator 150 is decreased. As this decreased output voltage of the comparator 150 is applied to the base of the npn transistor Q in the PWM controller 160, and since the collector of the npn transistor Q is grounded, the current running on the emitter of the npn transistor Q is decreased. Accordingly, the voltage of the comp terminal of the PWM IC 120 is decreased and the ‘on’ duration of the switching pulse outputted to the switch 130 is decreased, thereby decreasing the current supplied to the LED array 110.

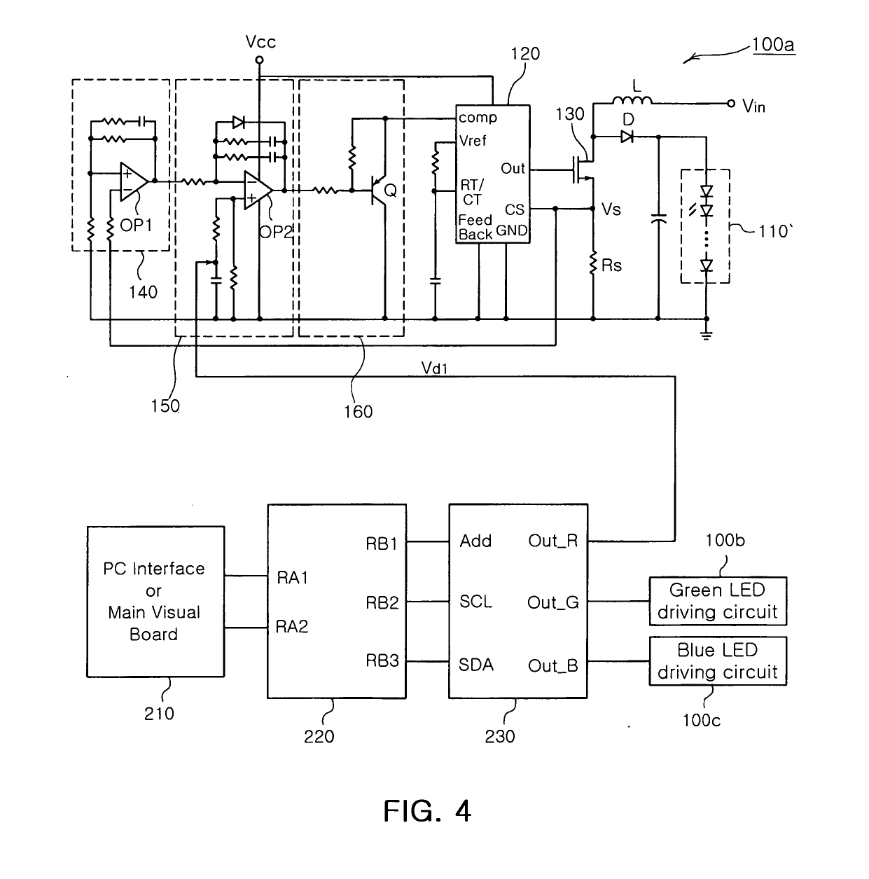

FIG. 4 is a block diagram illustrating another embodiment of the present invention. The embodiment illustrated in FIG. 4 includes constituent parts involved in generating the dimming voltage in response to the manipulation by the user. With reference to FIG. 4, in addition to the components shown in FIG. 3, the present invention according to this embodiment may further include an operator 210 for operating to adjust the luminance of the LED; a microcontroller 220 for generating luminance-adjusting signal in accordance with the operation by the operator; and a digital-analogue converter 230 for outputting the luminance-adjusting signal generated by the microcontroller as the dimming voltage Vd.

The operator 210 may be, for example, a PC interface operated by the user or an image board for automatically adjusting the brightness of the image.

The microcontroller 220 generates the luminance-adjusting signal corresponding to the operation by the operator 210. The microcontroller 220 generates the luminance-adjusting signal in a digital form corresponding to the operation by the operator 210 in accordance with a program stored in a memory inside the microcontroller 220.

The digital-analogue converter 230 converts a digital form of the luminance-adjusting signal outputted from the microcontroller into a corresponding analogue form of the dimming voltage value and provides the converted analogue signal to the comparator 150.

In general, a plurality of LEDs emitting red, blue and green light is used in the backlight of an LCD to generate white light. In FIG. 4, a circuit for driving a red LED is illustrated in detail, denoted by reference numeral 100a, and circuits for driving green and blue LEDs are illustrated in concise forms, denoted by reference numerals 100b and 100c, respectively. The circuit structures for the green and blue LEDs are illustrated in simple forms since they are identical to that for the red LED except that the green, blue LED arrays substitute the red LED array 110′. The green and blue LED driving circuits receive the dimming voltage outputted from the digital-analogue converter 230 and are operated in the same manner as described above.

As discussed above, the LED driving circuit having the dimming circuit according to the present invention compares the predetermined dimming voltage with the voltage detected by the voltage detection resistor of the DC-DC converter of the PWM method, thereby conveniently adjusting the current supplied to the LED.

In the present invention as set forth above, a detected voltage value provided to a PWM driver of an LED driving circuit and a dimming voltage provided from the outside are compared, and in accordance with a difference between the two values, an ‘on’ duration of the switching pulse outputted from the PWM driver is adjusted to manipulate luminance of an LED without using a variable resistor.

Furthermore, when the dimming voltage is maintained at a constant level, the constant current for maintaining a constant level of the current supplied to the LED can be controlled, thereby enhancing stability of the circuit.

While the present invention has been shown and described in connection with the preferred embodiments, it will be apparent to those skilled in the art that modifications and variations can be made without departing from the spirit and scope of the invention as defined by the appended claims.

What is claimed is:

1. A light emitting diode (LED) driving circuit having a dimming circuit comprising:
a Pulse Width Modulation (PWM) driver for providing a switching pulse having a width adjustable according to a voltage value detected by a voltage detecting resistor to control on/off durations of a switch;
a comparator for comparing the voltage value detected from the voltage detection resistor with a predetermined dimming voltage value; and
a PWM controller for generating a control signal to increase the ‘on’ duration of the switching pulse outputted from the PWM driver if a comparison value from the comparator is increased, and to decrease the ‘on’ duration of the switching pulse outputted from the PWM driver if the comparison value from the comparator is decreased,
wherein the width of the switching pulse outputted from the PWM driver is controlled according to the predetermined dimming voltage value to adjust luminance of an LEP.

2. The LED driving circuit having a dimming circuit according to claim 1, further comprising an amplifier for amplifying the voltage value detected from the voltage detecting resistor to provide to the comparator.

3. The LED driving circuit having a dimming circuit according to claim 1, wherein the PWM driver comprises a PWM IC having a comp terminal which increases the ‘on’ duration of the switching pulse when an applied voltage is increased and which decreases the ‘on’ duration of the switching pulse when the applied voltage is decreased, and
the control signal from the PWM controller is applied to the comp terminal.

4. The LED driving circuit having a dimming circuit according to claim 1, wherein the PWM controller comprises a base for receiving the comparison value applied from the comparator, an emitter connected to a comp terminal, and an npn transistor having a grounded collector.

5. The LED driving circuit having a dimming circuit according to claim 1, further comprising:
an operator for operating to adjust luminance of the LED;
a microcontroller for generating a luminance adjusting signal in accordance with the operation by the operator; and
a digital-analogue converter for outputting the luminance adjusting signal generated from the microcontroller as the predetermined dimming voltage.
